(19) United States
(12) Patent Application Publication
(10) Pub. No.: US 2026/0285154 A1
(43) Pub. Date: Sep. 24, 2026

(54) DISPLAY DEVICE, DISPLAY METHOD, AND STORAGE MEDIUM

(71) Applicant: HONDA MOTOR CO., LTD., Tokyo (JP)

(72) Inventors: Kazuki Kamata, Tokyo (JP); Tomotaka Teramachi, Tokyo (JP); Yugo Kajiwara, Tokyo (JP); Yuta Inaba, Tokyo (JP)

(21) Appl. No.: 19/544,061

(22) Filed: Feb. 19, 2026

(30) Foreign Application Priority Data
Mar. 19, 2025 (JP) 2025-044866

(51) Int. Cl. B60K 35/28; B60K 35/22; G01C 21/36

(52) U.S. Cl. CPC B60K 35/28; B60K 35/22; G01C 21/3676; B60K 2360/166; B60K 2360/179

(57) ABSTRACT

A display device includes a display control unit configured to cause an image selected by an occupant of a vehicle to be displayed on a display. The display control unit causes a first image to be displayed on the display when the vehicle exists within a predetermined section, continues to cause the first image to be displayed on the display while the vehicle exists within the predetermined section when the first image is selected by the occupant and the vehicle exists within the predetermined section, causes the first image to be displayed on the display from when the vehicle enters the predetermined section until a predetermined time has elapsed when a second image is selected by the occupant before the vehicle enters the predetermined section, and causes the second image to be displayed on the display after the predetermined time has elapsed.

### CROSS-REFERENCE TO RELATED APPLICATION

This application is based upon and claims the benefit of priority from Japanese Patent Application No. 2025-044866, filed Mar. 19, 2025, the entire content of which is incorporated herein by reference.

### BACKGROUND

### Field of the Invention

The present invention relates to a display device, a display method, and a storage medium.

### Description of Related Art

In recent years, initiatives to provide access to sustainable transportation systems that also give consideration to people who are in a vulnerable position among traffic participants have been intensifying. To realize this, efforts are being focused on research and development to further improve the safety or convenience of traffic through research and development regarding automated driving technology. Incidentally, as one driving assistance technology, a technology for outputting information for navigating an occupant to the presence of a target branching point (hereinafter referred to as “navigation information”) before a vehicle enters an area, such as a tunnel, in which radio waves from global navigation satellite system (GNSS) satellites are blocked, when the target branching point exists within such an area is known (see, for example, Japanese Unexamined Patent Application, First Publication No. 2013-113701).

### SUMMARY

In the related art, navigation information is continuously output over a period until a vehicle passes through an area in which radio waves of a GNSS satellite are blocked. Such continuous output of the navigation information may be bothersome for an occupant who wishes to know other information.

An object of the present invention is to reduce inconvenience imposed on an occupant by accurately providing information desired by the occupant in order to solve the above problem. As a result, the present invention contributes to the development of sustainable transportation systems.

A display device, a display method, and a storage medium according to the present invention adopt the following configurations.
(1) A first aspect of the present invention is A display device including: an output interface including at least a display; an input interface operated by an occupant of a vehicle; and a display control unit configured to, when the occupant selects any one of a plurality of images that are candidates to be displayed on the display using the input interface, cause the image selected by the occupant to be displayed on the display, wherein the display control unit is configured to cause a first image included in the plurality of images to be displayed on the display when the vehicle exists within a predetermined section; continue to cause the first image to be displayed on the display over a period during which the vehicle exists within the predetermined section, when the first image is selected by the occupant and the vehicle exists within the predetermined section; cause the first image to be displayed on the display when the vehicle enters the predetermined section; cause the first image to be displayed on the display during a period from when the vehicle enters the predetermined section until a predetermined time has elapsed, when a second image included in the plurality of images and different from the first image is selected by the occupant before the vehicle enters the predetermined section, and cause the second image to be displayed on the display after the predetermined time has elapsed.
(2) A second aspect of the present invention is the display device according to the first aspect, wherein the display control unit guides a route to a destination using the output interface; and causes the first image to be displayed on the display again when the vehicle has reached a predetermined point ahead of a guidance point present on the route, the guidance point being a point at which a traveling direction of the vehicle is to be changed after causing the second image to be displayed on the display.
(3) A third aspect of the present invention is the display device according to the second aspect, wherein the display control unit continues to cause the first image to be displayed on the display even after the vehicle enters the predetermined section when the first image is selected by the occupant before the vehicle enters the predetermined section.
(4) A fourth aspect of the present invention is the display device according to the second aspect, wherein the display control unit outputs, using the output interface, guidance information indicating that the guidance point is becoming closer before the vehicle reaches the guidance point, causes the first image to be displayed on the display when the vehicle does not move in accordance with the guided route after the guidance information is output, and does not cause the first image to be displayed on the display when the vehicle has moved in accordance with the guided route after the guidance information is output.
(5) A fifth aspect of the present invention is the display device according to the second aspect, wherein the display control unit to causes the second image to be displayed on the display when the vehicle has passed through the predetermined point.
(6) A sixth aspect of the present invention is the display device according to the first aspect, wherein the display control unit causes the first image to be displayed on the display during a period from when the vehicle enters the predetermined section until a predetermined time has elapsed, when a third image included in the plurality of images and different from the first image and the second image is selected by the occupant before the vehicle enters the predetermined section, and cause the first image to continue to be displayed on the display after the predetermined time has elapsed.
(7) A seventh aspect of the present invention is the display device according to the first aspect, wherein the predetermined section is a section in which an expressway or an automobile-only road exists.
(8) An eighth aspect of the present invention is the display device according to the first aspect, wherein the first image includes guidance information for guiding the occupant to positions of a host lane that is a lane in which the vehicle exists, an adjacent lane that is another lane adjacent to the host lane, an object present around the vehicle, and a recommended lane that is a lane recommended to be traveled by the vehicle.
(9) A ninth aspect of the present invention is a display method using a computer mounted on a vehicle including an output interface including at least a display, and an input interface, the display method including: causing an image selected by an occupant of the vehicle to be displayed on the display when the occupant selects any one of a plurality of images that are candidates to be displayed on the display using the input interface; causing a first image included in the plurality of images to be displayed on the display when the vehicle exists within a predetermined section; continuing to cause the first image to be displayed on the display over a period during which the vehicle exists within the predetermined section, when the first image is selected by the occupant and the vehicle exists within the predetermined section; causing the first image to be displayed on the display when the vehicle enters the predetermined section; causing the first image to be displayed on the display during a period from when the vehicle enters the predetermined section until a predetermined time has elapsed, when a second image included in the plurality of images and different from the first image is selected by the occupant before the vehicle enters the predetermined section; and causing the second image to be displayed on the display after the predetermined time has elapsed.
(10) A tenth aspect of the present invention is a non-transitory storage medium storing a program caused to be executed by a computer mounted on a vehicle including an output interface including at least a display, and an input interface, the program including: causing an image selected by an occupant of the vehicle to be displayed on the display when the occupant selects any one of a plurality of images that are candidates to be displayed on the display using the input interface; causing a first image included in the plurality of images to be displayed on the display when the vehicle exists within a predetermined section; continuing to cause the first image to be displayed on the display over a period during which the vehicle exists within the predetermined section, when the first image is selected by the occupant and the vehicle exists within the predetermined section; causing the first image to be displayed on the display when the vehicle enters the predetermined section; causing the first image to be displayed on the display during a period from when the vehicle enters the predetermined section until a predetermined time has elapsed, when a second image included in the plurality of images and different from the first image is selected by the occupant before the vehicle enters the predetermined section; and causing the second image to be displayed on the display after the predetermined time has elapsed.

According to the above aspects, it is possible to reduce inconvenience imposed on an occupant by accurately providing information desired by the occupant.

### BRIEF DESCRIPTION OF THE DRAWINGS

FIG. 1 is a configuration diagram of a vehicle system using a display device of an embodiment.

FIG. 2 is a diagram schematically illustrating an interior state of a host vehicle.

FIG. 3 is a functional block diagram of a first control unit, a second control unit, and a third control unit of the embodiment.

FIG. 4 is a flowchart illustrating an example of a flow of a series of processes performed by an automated driving control device of the embodiment.

FIG. 5 is a diagram illustrating an example of a situation in which a host vehicle is traveling.

FIG. 6 is a diagram illustrating an example of a navigation map.

FIG. 7 is a diagram illustrating an example of an ADAS view with auxiliary information.

FIG. 8 is a diagram illustrating an example of a navigation map with auxiliary information.

FIG. 9 is a diagram illustrating another example of the ADAS view with auxiliary information.

FIG. 10 is a diagram illustrating another example of the navigation map with auxiliary information.

FIG. 11 is a diagram illustrating an example of an ADAS view without auxiliary information.

FIG. 12 is a diagram illustrating another example of the ADAS view with auxiliary information.

FIG. 13 is a diagram illustrating another example of the ADAS view with auxiliary information.

FIG. 14 is a diagram illustrating another example of the ADAS view with auxiliary information.

### DESCRIPTION OF EMBODIMENTS

Hereinafter, embodiments of the display device, the display method, and the storage medium of the present invention will be described with reference to the drawings.

The display device of the embodiment is applicable, for example, to an automated driving vehicle. Automated driving refers, for example, to controlling the driving of a vehicle by controlling one or both of speed and steering of the vehicle. Driving control of the vehicle described above includes various types of driving control such as adaptive cruise control system (ACC), traffic jam pilot (TJP), auto lane changing (ALC), collision mitigation brake system (CMBS), and lane keeping assistance system (LKAS). Driving of the automated driving vehicle may also be controlled by manual driving of an occupant (driver). Hereinafter, a case in which a left-hand traffic regulation applies will be described, but when a right-hand traffic regulation applies, left and right may be read in reverse.

### Overall Configuration

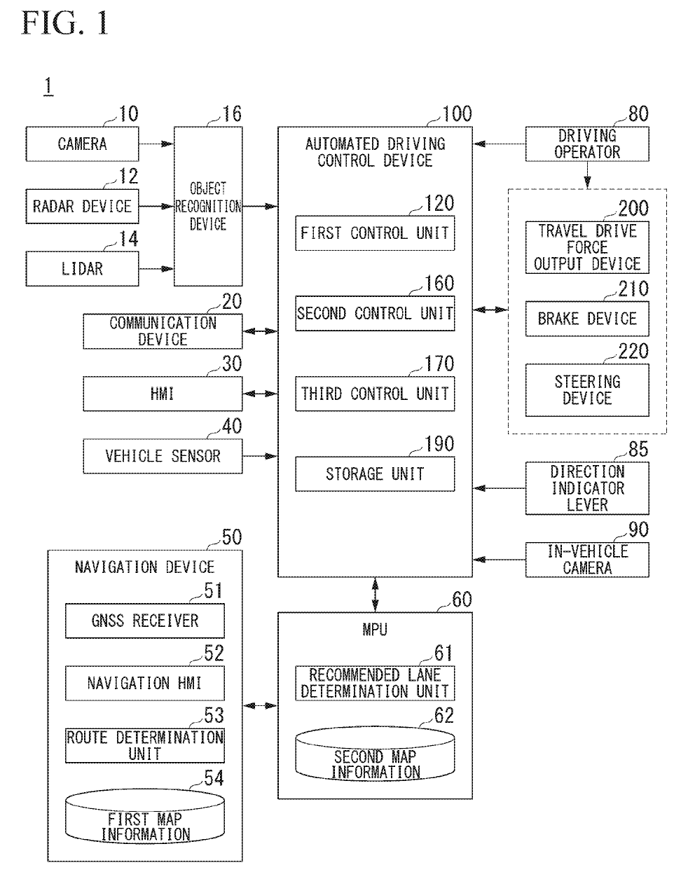

FIG. 1 is a configuration diagram of a vehicle system 1 using a display device according to an embodiment. A vehicle on which the vehicle system 1 is mounted (hereinafter referred to as a “host vehicle M”) is, for example, a two-wheeled, three-wheeled, or four-wheeled vehicle, and a drive source thereof includes an internal combustion engine such as a diesel engine or a gasoline engine, an electric motor, or a combination thereof. The electric motor operates using electric power generated by a generator coupled to the internal combustion engine, or electric power discharged from a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, vehicle sensors 40, a navigation device 50, a map positioning unit (MPU) 60, a driving operator 80, a direction indicator lever 85, an in-vehicle camera 90, an automated driving control device 100, a travel drive force output device 200, a brake device 210, and a steering device 220. These devices or units are interconnected by a multiplex communication line such as a controller area network (CAN) communication line, a serial communication line, or a wireless communication network, or the like. The configuration illustrated in FIG. 1 is merely an example, part of the configuration may be omitted, or additional configurations may be added. In particular, a combination of the HMI 30, the navigation device 50, the MPU 60, and the automated driving control device 100 is an example of a “display device.”

The camera 10 is, for example, a digital camera that uses a solid-state imaging element such as a charge coupled device (CCD) or a complementary metal oxide semiconductor (CMOS). The camera 10 is attached at any location on the host vehicle M. When the camera 10 images the front of the host vehicle M, the camera 10 may be attached on an upper part of a front windshield, on a back surface of the room mirror, or the like. When the camera 10 images the rear of the host vehicle M, the camera 10 may be attached on an upper part of the rear windshield, or the like. When the camera 10 images a right or left side of the host vehicle M, the camera 10 may be attached to, for example, a right or left side surface of a vehicle body or door mirror. The camera 10 periodically and repeatedly images the surroundings of the host vehicle M, for example. The camera 10 may be a stereo camera.

The radar device 12 radiates radio waves such as millimeter waves to the surroundings of the host vehicle M and detects radio waves (reflected waves) reflected by an object, thereby detecting at least a position (distance and direction) of the object. The radar device 12 may be attached at any location on the host vehicle M. The radar device 12 may detect the position and speed of the object using a frequency modulated continuous wave (FM-CW) scheme.

The LIDAR 14 irradiates light to the surroundings of the host vehicle M and measures scattered light of the irradiated light. The LIDAR 14 detects a distance to a target based on time from emission to reception. The irradiated light may be, for example, pulsed laser light. The LIDAR 14 may be attached at any location on the host vehicle M.

The object recognition device 16 performs sensor-fusion processing on detection results obtained by some or all of the camera 10, the radar device 12, and the LIDAR 14, and recognizes, for example, the position, type, and speed of the object. The object recognition device 16 outputs the recognition results to the automated driving control device 100. The object recognition device 16 may output detection results of the camera 10, the radar device 12, and the LIDAR 14 directly to the automated driving control device 100. The object recognition device 16 may be omitted from the vehicle system 1.

The communication device 20 uses, for example, a cellular network, a Wi-Fi network, Bluetooth (registered trademark; hereinafter omitted), dedicated short range communication (DSRC), or the like to communicate with other vehicles present around the host vehicle M or communicate with various server devices via a wireless base station.

The HMI 30 presents various kinds of information to occupants of the host vehicle M and accepts input operations from the occupants. For example, the HMI 30 includes a display device 32 and a command switch 34. The display device 32 includes, for example, a first display 32A and a second display 32B. The HMI 30 may further include a speaker, a buzzer, a touch panel, a microphone, and the like. The display device 32, the speaker, the buzzer, and the like included in the HMI 30 are examples of an “output interface,” and the command switch 34, the touch panel, the microphone, and the like included in the HMI 30 are examples of an “input interface.”

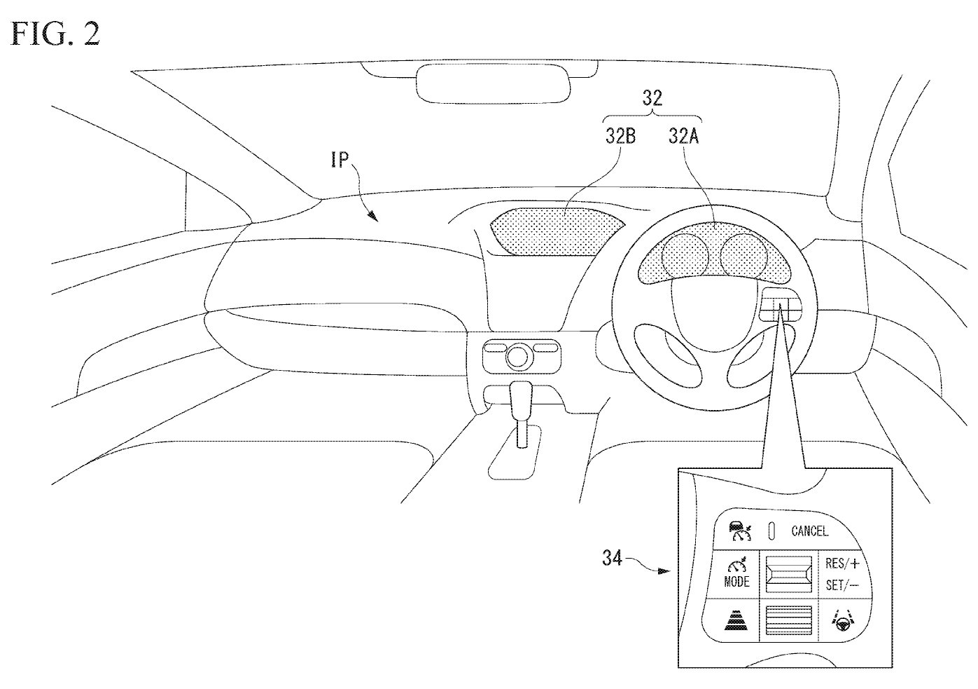

FIG. 2 is a diagram schematically illustrating a state inside the host vehicle M. For example, the first display 32A is provided near the front of a driver’s seat (a seat closest to a steering wheel) on an instrument panel IP, and is installed at a position that the occupant can visually recognize through a gap in the steering wheel or over the steering wheel.

The first display 32A is, for example, a liquid crystal display (LCD) or an organic electro luminescence (EL) display device. The first display 32A displays, as an image, information necessary for travel during manual driving or driving assistance of the host vehicle M. The information necessary for the travel of the host vehicle M during manual driving includes, for example, speed, engine speed, remaining fuel, radiator water temperature, travel distance, remaining battery level, and other information of the host vehicle M. The information necessary for the travel of the host vehicle M during driving assistance includes, for example, a future trajectory of the host vehicle M (a target trajectory to be described later), whether a lane change will occur, a lane that is a lane change destination, and information on recognized lanes (lane markings), other vehicles. Further, the information necessary for the travel of the host vehicle M during driving assistance may include some or all of the information necessary for the travel of the host vehicle M during manual driving. The first display 32A is an example of a “display.”

The second display 32B is installed, for example, near a center of the instrument panel IP. The second display 32B is, for example, an LCD or organic EL display device, like the first display 32A. The second display 32B displays, for example, a navigation results of the navigation device 50 as an image. The second display 32B may display television programs, play DVDs, or display content such as downloaded movies.

The command switch 34 is typically attached to the steering wheel. The command switch 34 may be a single switch or may be an assembly in which a plurality of switches are integrated. The command switch 34 may be attached to a steering column cover or the vicinity thereof instead of or in addition to the steering wheel, may be attached on the instrument panel IP, or may be attached to a center console.

The vehicle sensor 40 includes a vehicle-speed sensor that detects speed of the host vehicle M, an acceleration sensor that detects acceleration, a yaw-rate sensor that detects an angular velocity around a vertical axis, and a direction sensor that detects an orientation of the host vehicle M.

The navigation device 50 includes, for example, a global navigation satellite system (GNSS) receiver 51, a navigation human machine interface (HMI) 52, and a route determination unit 53. The navigation device 50 stores first map information 54 in a storage device such as a hard disk drive (HDD) or a flash memory.

The GNSS receiver 51 determines the position of the host vehicle M based on signals received from GNSS satellites. The position of the host vehicle M may also be determined or supplemented by an inertial navigation system (INS) using an output of the vehicle sensor 40.

The navigation HMI 52 includes a display device, a speaker, a touch panel, keys, and the like. Part or all of the navigation HMI 52 may be shared with the HMI 30 described above. For example, instead of or in addition to inputting a destination of the host vehicle M via the HMI 30, the occupant may input the destination of the host vehicle M via the navigation HMI 52.

The route determination unit 53 determines, for example, a route (hereinafter referred to as a “map route”) from a position of the host vehicle M identified by the GNSS receiver 51 (or any input position) to the destination entered by the occupant using the HMI 30 or the navigation HMI 52, with reference to the first map information 54.

The first map information 54 is, for example, information in which a road geometry is represented by links indicating roads and nodes connected by the links. The first map information 54 may include, for example, road curvature or point of interest (POI) information. The map route is output to the MPU 60.

The navigation device 50 may provide route guidance using the navigation HMI 52 based on the map route. The navigation device 50, for example, may also be realized using functions of a terminal device such as a smartphone or tablet owned by the occupant. The navigation device 50 may transmit a current location and destination to a navigation server via the communication device 20 and acquire a route equivalent to the map route from the navigation server.

The MPU 60 includes, for example, a recommended-lane determination unit 61 and stores second map information 62 in a storage device such as an HDD or flash memory. The recommended-lane determination unit 61 divides the map route provided by the navigation device 50 into a plurality of blocks (for example, every 100 meters in a direction in which the vehicle travels) and determines a recommended lane for each block by referring to the second map information 62.

The recommended lane is a lane that is recommended to be traveled by the host vehicle M among one or more lanes formed on a road on which the host vehicle M exists. The recommended lane may be read as a target lane.

The recommended-lane determination unit 61 determines, for example, which lane number from the left the vehicle travels in. When there is a branch location on the map route, the recommended-lane determination unit 61 determines a recommended lane that allows the host vehicle M to travel on a reasonable route toward a branch destination.

The second map information 62 is higher accuracy map information than the first map information 54. The second map information 62 includes, for example, information on a center of a lane or a boundary of the lane. Further, the second map information 62 may include road information, traffic regulation information, address information (address/postal code), facility information, telephone number information, and the like. The second map information 62 may be updated as needed through communication of the communication device 20 with other devices.

The driving operator 80 includes, for example, an accelerator pedal, a brake pedal, a shift lever, a steering wheel, an irregular steering wheel, a joystick, and another operator. Sensors that detect an amount of operation or whether the operation has occurred are attached to the driving operator 80, and detection results thereof are output to the automated driving control device 100 or to some or all of the travel drive force output device 200, the brake device 210, and the steering device 220.

For example, a sensor attached to the steering wheel (hereinafter, a steering sensor) detects subtle electric current generated when the occupant touches the steering wheel (for example, a change in capacitance). The steering sensor may also detect steering torque generated around the steering wheel’s rotational axis (shaft). When the steering sensor detects electric current or steering torque, the steering sensor outputs a signal indicating the detection result to the automated driving control device 100.

The direction indicator lever 85 (also referred to as a stalk or a switch), when operated by an occupant, turns on lamps attached to front and rear of the host vehicle M. Further, the direction indicator lever 85 is also operated to instruct a lane change of the host vehicle M. Operating the direction indicator lever 85 to instruct a lane change is also referred to as a one-touch function. Hereinafter, operating the direction indicator lever 85 to instruct a lane change will be referred to as a “lane change instruction operation.”

A lane change instruction may be made by inputting voice to a microphone included in the HMI 30 in addition to or instead of operating the direction indicator lever 85, or may be made by operating the touch panel included in the HMI 30 or another switch.

The in-vehicle camera 90 is a camera that images a cabin of the host vehicle M. The in-vehicle camera 90 is, for example, a digital camera that uses a solid-state imaging device such as a CCD or CMOS. When the in-vehicle camera 90 images the cabin of the host vehicle M, the in-vehicle camera 90 outputs image data to the automated driving control device 100.

The automated driving control device 100 includes, for example, a first control unit 120, a second control unit 160, a third control unit 170, and a storage unit 190. Each of the first control unit 120, the second control unit 160, and the third control unit 170 is realized, for example, by a hardware processor such as a central processing unit (CPU) or a graphics processing unit (GPU) executing a program (software). Some or all of these components may be realized by hardware (including circuitry), such as large scale integration (LSI), an application specific integrated circuit (ASIC), a field-programmable gate array (FPGA), or a system on chip (SOC), or may be realized by cooperation between software and hardware. The program may be stored in advance in a storage device of the automated driving control device 100, such as a hard disk drive (HDD) or flash memory (a storage device including a non-transitory storage medium), or may be stored in a removable storage medium such as a digital versatile disc (DVD) or compact disc read-only memory (CD-ROM) and installed in the HDD or flash memory of the automated driving control device 100 by the storage medium (non-transitory storage medium) mounted in a drive device.

The storage unit 190 is realized by various storage devices described above. The storage unit 190 is realized, for example, by an HDD, flash memory, electrically erasable programmable read-only memory (EEPROM), read only memory (ROM), or random access memory (RAM). The storage unit 190 stores, for example, programs (instructions) that are read out and executed by a processor.

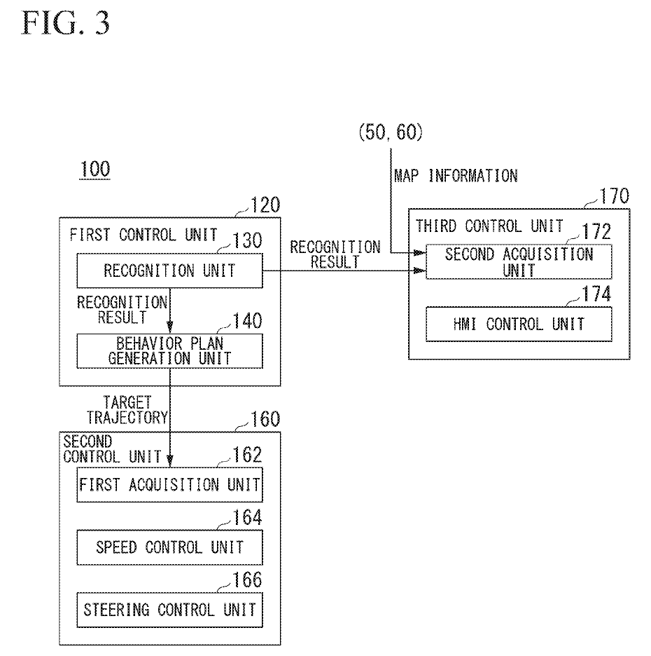

FIG. 3 is a functional configuration diagram of the first control unit 120, the second control unit 160, and the third control unit 170 according to an embodiment. The first control unit 120 includes, for example, a recognition unit 130 and a behavior plan generation unit 140.

The first control unit 120 realizes, for example, functions using artificial intelligence (AI) and functions based on a predetermined model in parallel. For example, a function of “recognizing an intersection” may be realized by performing, in parallel, recognition of the intersection using deep learning or the like and recognition based on predetermined conditions (there are, for example, signals and road markings that allow pattern matching), scoring both, and performing comprehensive evaluation. This ensures the reliability of automated driving.

The recognition unit 130 recognizes a surrounding situation or environment of the host vehicle M. For example, the recognition unit 130 recognizes objects present around the host vehicle M based on information input from the camera 10, the radar device 12, and the LIDAR 14 via the object recognition device 16. The objects recognized by the recognition unit 130 include, for example, bicycles, motorcycles, four-wheeled vehicles, pedestrians, road signs, road markings, lane markings, utility poles, guardrails, and fallen objects. Further, the recognition unit 130 recognizes states such as a position, speed, and acceleration of the object. The position of the object is recognized, for example, as a position on a relative coordinate system with a representative point of the host vehicle M (such as a center of gravity or a drive shaft center) as an origin (that is, a relative position with respect to the host vehicle M) and is used for control. The position of the object may be represented by a representative point such as a center of gravity or corner of the object, or may be represented by a represented region. The “state” of the object may include acceleration, jerk, or “behavioral state” (for example, whether the object is changing lanes or is about to change lanes) of the object.

Further, the recognition unit 130 recognizes, for example, the lane in which the host vehicle M is traveling (hereinafter, a host lane) and another lane adjacent to the host lane (hereinafter referred to as an adjacent lane). For example, the recognition unit 130 recognizes the host lane and adjacent lanes by comparing a pattern (for example, an arrangement of solid lines and broken lines) of a road lane marking obtained from the second map information 62 with a pattern of a road lane marking around the host vehicle M recognized from an image captured by the camera 10.

Further, the recognition unit 130 may recognize lanes such as the host lane or adjacent lanes by recognizing not only road lane markings but also a travel path boundary (road boundary) including road lane markings, shoulders, curbs, medians, guardrails, and the like. In this recognition, a position of the host vehicle M acquired from the navigation device 50 or processing results by the INS may be taken into account. The recognition unit 130 may also recognize stop lines, obstacles, red signals, tollgates, and other road events.

When the recognition unit 130 recognizes the host lane, the recognition unit 130 recognizes a relative position or posture of the host vehicle M with respect to the host lane. For example, the recognition unit 130 may recognize a deviation of a reference point of the host vehicle M from a center of the lane, and an angle formed with respect to a line connecting centers of the lane in a direction in which the host vehicle M travels, as a relative position and posture of the host vehicle M with respect to the host lane. Alternatively, the recognition unit 130 may recognize, for example, a position of the reference point of the host vehicle M with respect to either side edge of the host lane (the road lane marking or the road boundary) as the relative position of the host vehicle M with respect to the host lane.

When the host vehicle M is under automated driving on a route in which a recommended lane has been determined, the behavior plan generation unit 140 determines a driving mode of the automated driving. Hereinafter, information defining the driving mode of automated driving will be referred to as an event.

Events include, for example, a constant-speed driving event, a following driving event, a lane change event, a branching event, a merging event, and a takeover event. The constant-speed driving event is a driving mode in which the host vehicle M is caused to travel in the same lane at a constant speed. The following driving event is a driving mode in which the host vehicle M is caused to follow another vehicle (hereinafter referred to as a preceding vehicle) that is present within a predetermined distance (for example, within 100 meters) in front of the host vehicle M in the host lane and is closest to the host vehicle M.

“To follow” may refer to a driving mode in which an inter-vehicle distance (relative distance) between the host vehicle M and the preceding vehicle is maintained constant, or a driving mode in which the host vehicle M is caused to travel in a center of the host lane, in addition to the inter-vehicle distance between the host vehicle M and the preceding vehicle being maintained constant.

The lane change event is a driving mode in which the host vehicle M is caused to change lanes from the host lane to an adjacent lane. The branching event is a driving mode in which, at a branch point in a road, the host vehicle M is caused to branch into a lane on the destination side. The merging event is a driving mode in which, at a merging point, the host vehicle M is caused to merge into a main lane. The takeover event is a driving mode in which automated driving is terminated and switched to manual driving.

Further, events may include, for example, an overtaking event or an avoidance event. The overtaking event is a driving mode in which the host vehicle M is first caused to change lanes to an adjacent lane to overtake a preceding vehicle in the adjacent lane and then caused to change lanes back to the original lane. The avoidance event is a driving mode in which the host vehicle M is caused to perform at least one of braking and steering in order to avoid an obstacle present in front of the host vehicle M.

Further, the behavior plan generation unit 140 may also change an event already determined for a current section to another event or determine a new event for the current section according to the surrounding situation recognized by the recognition unit 130 during the travel of the host vehicle M.

Further, the behavior plan generation unit 140 may determine an event in accordance with an occupant’s operation with respect to the direction indicator lever 85 (or a switch, button, or the like used in place thereof). For example, when the occupant operates the direction indicator lever 85 to signal a left turn, the behavior plan generation unit 140 determines a lane change event in which the host vehicle M is caused to change lanes to an adjacent lane on the left side as viewed from the host vehicle M. Further, for example, when the occupant operates the direction indicator lever 85 to signal a right turn, the behavior plan generation unit 140 determines a lane change event in which the host vehicle M is caused to change lanes to an adjacent lane on the right side as viewed from the host vehicle M.

The behavior plan generation unit 140 generates a future target trajectory for automatically (that is, without depending on the driver’s operation) causing the host vehicle M to travel in the travel mode defined by the event, in principle, so that the host vehicle M travels on the recommended lane determined by the recommended-lane determination unit 61 and the host vehicle M responds to the surrounding situation while traveling on the recommended lane. The target trajectory includes, for example, a position element defining a future position of the host vehicle M and a speed element defining, for example, a future speed of the host vehicle M.

For example, the behavior plan generation unit 140 determines, as the position element of the target trajectory, a plurality of points (trajectory points) that the host vehicle M should sequentially reach. The trajectory point is a point that the host vehicle M should reach for each predetermined travel distance (for example, several [m]). The predetermined travel distance may be calculated, for example, based on a road-following distance when the vehicle travels along a route.

Further, the behavior plan generation unit 140 determines, as the speed element of the target trajectory, a target speed and a target acceleration for each predetermined sampling time (for example, on the order of zero point several seconds). Further, each trajectory point may be a position that the host vehicle M should reach at a sampling timing corresponding to each predetermined sampling time. In this case, the target speed and target acceleration are determined by the sampling time and an interval between the trajectory points. The behavior plan generation unit 140 outputs information indicating the generated target trajectory to the second control unit 160.

The second control unit 160 controls the travel drive force output device 200, the brake device 210, and the steering device 220 so that the host vehicle M passes through the target trajectory generated by the behavior plan generation unit 140 at a scheduled time.

The second control unit 160 includes, for example, a first acquisition unit 162, a speed control unit 164, and a steering control unit 166.

The first acquisition unit 162 acquires information on the target trajectory (trajectory points) from the behavior plan generation unit 140 and stores the information in the memory of the storage unit 190.

The speed control unit 164 controls one or both of the travel drive force output device 200 and the brake device 210 based on the speed elements (for example, target speed or target acceleration) included in the target trajectory stored in the memory.

The steering control unit 166 controls the steering device 220 in accordance with the position element (for example, a curvature representing a degree of bending of the target trajectory) included in the target trajectory stored in the memory.

The processing of the speed control unit 164 and the steering control unit 166 is realized, for example, by a combination of feedforward control and feedback control. As one example, the steering control unit 166 executes a combination of feedforward control according to a curvature of a road ahead of the host vehicle M and feedback control based on a deviation from the target trajectory.

The travel drive force output device 200 outputs travel drive force (torque) for travel of the vehicle to drive wheels. The travel drive force output device 200 includes, for example, a combination of an internal combustion engine, an electric motor, and a transmission, and a power electronic control unit (ECU) that controls these components. The power ECU controls the above configuration according to information input from the second control unit 160 or information input from the driving operator 80.

The brake device 210 includes, for example, a brake caliper, a cylinder for transmitting hydraulic pressure to the brake caliper, an electric motor for generating hydraulic pressure in the cylinder, and a brake ECU. The brake ECU controls the electric motor according to the information input from the second control unit 160 or the information input from the driving operator 80, so that brake torque corresponding to a braking operation is output to each wheel. The brake device 210 may include, as a backup, a mechanism that transmits hydraulic pressure generated by operating the brake pedal included in the driving operator 80 to the cylinder via a master cylinder. The brake device 210 is not limited to the above configuration; and may also be an electronically controlled hydraulic brake device that controls an actuator according to the information input from the second control unit 160 to transmit the hydraulic pressure from the master cylinder to the cylinder.

The steering device 220 includes, for example, a steering ECU and an electric motor. The electric motor, for example, applies force to a rack-and-pinion mechanism to change directions of the steered wheels. The steering ECU drives the electric motor according to the information input from the second control unit 160 or the information input from the driving operator 80, thereby changing the directions of the steered wheels.

The third control unit 170 includes a second acquisition unit 172 and an HMI control unit 174.

The second acquisition unit 172, for example, may acquire a recognition result of the recognition unit 130, acquire a first map including a route to the destination from the navigation device 50, or acquire a second map including a recommended lane from the MPU 60. The second acquisition unit 172 provides acquired various types of information to the HMI control unit 174.

The HMI control unit 174 controls the HMI 30 based on the various types of information acquired by the second acquisition unit 172. The HMI control unit 174 is an example of a “display control unit.”

For example, when an occupant selects one of a plurality of images that are candidates to be displayed on a screen of the first display 32A using the command switch 34, the HMI control unit 174 causes the image selected by the occupant to be displayed on the screen of the first display 32A.

The selection of the image may be performed by inputting voice to the microphone included in the HMI 30 in addition to or instead of operating the command switch 34 or may be performed by operating the touch panel included in the HMI 30 or another switch.

The plurality of images that are candidates to be displayed on the screen of the first display 32A may include, for example, the first map including the route to the destination provided from the navigation device 50 and the second map including the recommended lane provided from the MPU 60. The first map and the second map may be further subdivided into, for example, a bird’s-eye view, a two-dimensional view (2D view), and a three-dimensional view (3D view). Hereinafter, the first map and the second map, or the bird’s-eye view, the two-dimensional view, or the three-dimensional view obtained by further subdividing the first map and the second map will be collectively referred to as a “navigation map” for description. The navigation map is an example of a “second image.”

The plurality of images may further include an advanced driver-assistance systems (ADAS) view, in addition to the navigation map.

The ADAS view is an image for notifying an occupant of a lane in which the host vehicle M should reasonably travel in order to reach the destination (that is, the recommended lane) as one advanced driver assistance, and/or for notifying the occupant of the presence of objects around the host vehicle M. The ADAS view is an example of a “first image.”

The ADAS view may include at least a host lane and an adjacent lane among a plurality of lanes recognized by the recognition unit 130, include lane markings of the host lane and the adjacent lane, and include the host vehicle M whose relative position with respect to the host lane has been recognized.

Furthermore, the ADAS view may include objects existing around the host vehicle M and a lane change guide LCG.

The lane change guide LCG is a guide for guiding, to an occupant of the host vehicle M, a position of the recommended lane determined by the MPU 60 (more specifically, a relative position of the recommended lane with respect to another lane). For example, the lane change guide LCG may be represented by a plurality of arrows arranged in a direction in which the lane extends. The lane change guide LCG or auxiliary information to be described later are examples of “guidance information.”

### Processing Flow

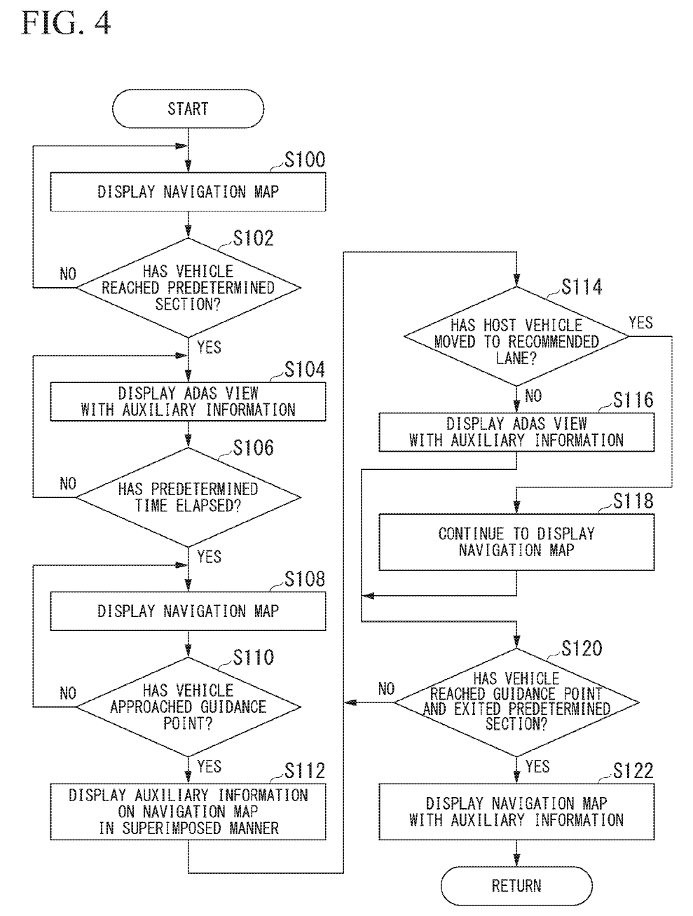

Hereinafter, a flow of a series of processes performed by the automated driving control device 100 of the embodiment will be described using a flowchart. FIG. 4 is a flowchart illustrating an example of a flow of a series of processes performed by the automated driving control device 100 of the embodiment.

The processing of the present flowchart may be repeatedly executed at a predetermined cycle, for example, when the occupant selects a navigation map from among a plurality of images using the command switch 34 before the host vehicle M reaches (enters) a predetermined section.

The predetermined section is, for example, a section in which an expressway exists or a section in which an automobile-only road exists.

First, the HMI control unit 174 causes the navigation map selected by the occupant to be displayed on the screen of the first display 32A (step S100).

Next, the HMI control unit 174 determines whether the host vehicle M has reached the predetermined section (step S102).

When the host vehicle M has not reached the predetermined section, that is, when the host vehicle M has not entered the predetermined section, the HMI control unit 174 continues to cause the navigation map to be displayed on the screen of the first display 32A.

On the other hand, when the host vehicle M has reached the predetermined section, that is, when the host vehicle M has entered the predetermined section, the HMI control unit 174 causes an ADAS view with auxiliary information to be displayed on the screen of the first display 32A (step S104). In other words, the HMI control unit 174 causes the screen of the first display 32A to transition from the navigation map to the ADAS view with auxiliary information.

The auxiliary information is other information that cannot be fully delivered to the occupant by the ADAS view alone. For example, the auxiliary information includes information for notifying the occupant that, when various events such as a branching event and a merging event are planned within the predetermined section, a guidance point (for example, a branching point or a merging point) at which a traveling path of the vehicle is to be changed in accordance with such event(s) is becoming closer, and/or for notifying the occupant that guidance for the recommended lane will start.

When the HMI control unit 174 causes the ADAS view with auxiliary information to be displayed on the screen of the first display 32A, the HMI control unit 174 may cause sound to be output from the speaker of the HMI 30. Thus, the occupant can be notified that the screen of the first display 32A has transitioned to the ADAS view.

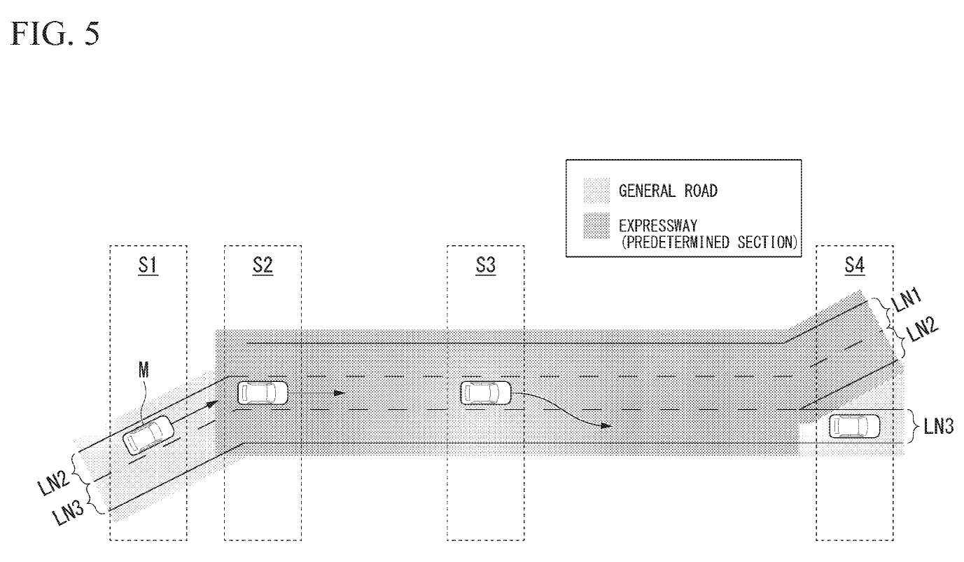

FIG. 5 is a diagram illustrating an example of a situation in which the host vehicle M is traveling. As illustrated in FIG. 5, the situation can be classified into several scenes S1 to S4.

In scene S1, the host vehicle M is traveling on a general road and has not reached the predetermined section (for example, an expressway). In such a case, the navigation map preselected by the occupant is displayed on the screen of the first display 32A.

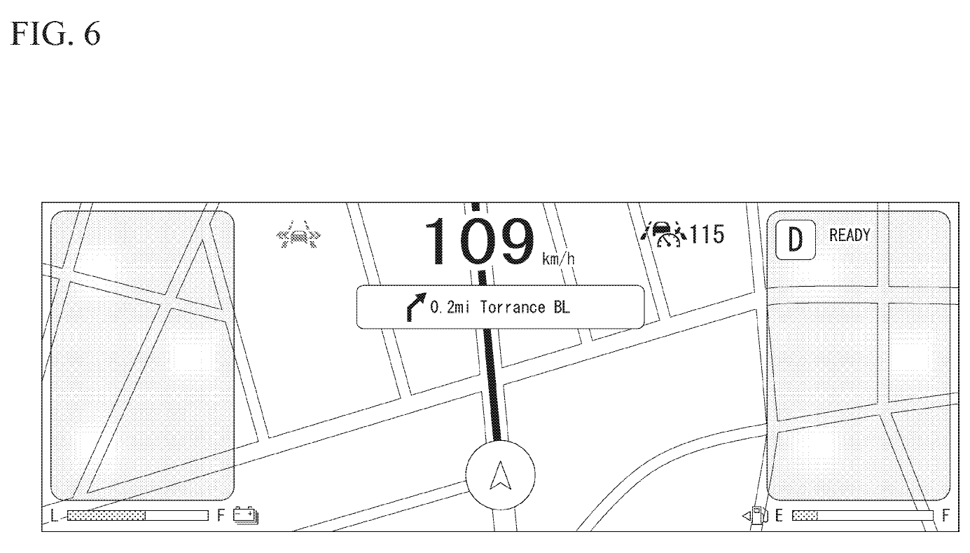

FIG. 6 is a diagram illustrating an example of the navigation map. In the illustrated example, a navigation map including a current position of the host vehicle M or a route to a destination is displayed as a bird’s-eye view.

In scene S2, the host vehicle M has reached the predetermined section (for example, an expressway). In such a case, the ADAS view with auxiliary information is displayed on the screen of the first display 32A.

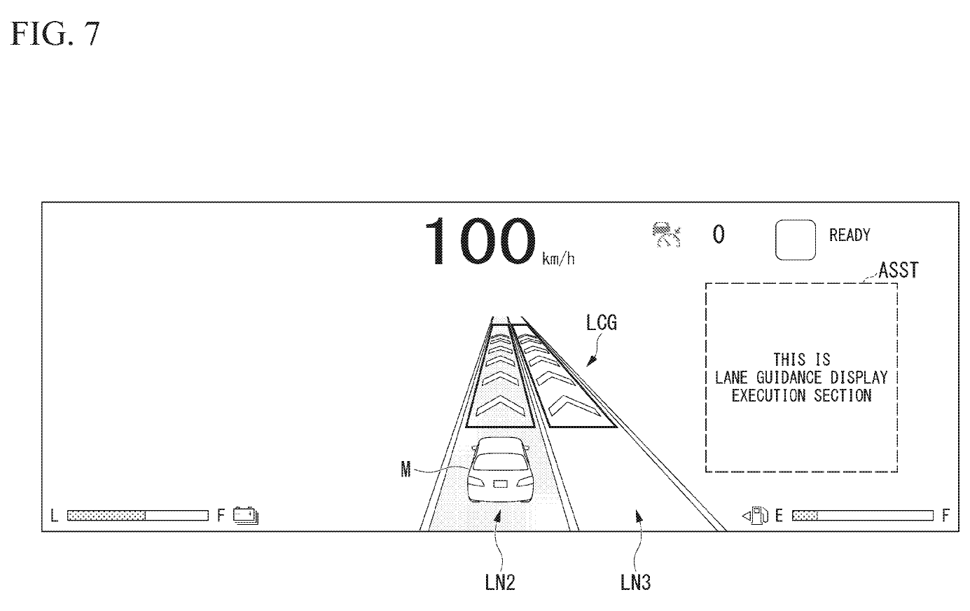

FIG. 7 is a diagram illustrating an example of the ADAS view with auxiliary information. In the figure, ASST represents the auxiliary information. As in the illustrated example, the ADAS view includes a lane LN2 in which the host vehicle M is traveling in scene S2, a lane LN3 adjacent to the lane LN2, the host vehicle M, the lane change guide LCG, and the like. Further, in scene S2, the host vehicle M has reached the predetermined section. Therefore, text such as “This is a lane guidance display execution section” is superimposed as auxiliary information ASST on the ADAS view in order to notify the occupant that guidance of the recommended lane will start.

The description returns to the flowchart, Next, the HMI control unit 174 determines whether a predetermined time (for example, several seconds) has elapsed after displaying the ADAS view on the screen of the first display 32A (step S106). In other words, the HMI control unit 174 determines whether the predetermined time has elapsed after the host vehicle M has reached (entered) the predetermined section.

When the predetermined time has not elapsed, the HMI control unit 174 continues to cause the ADAS view to be displayed on the screen of the first display 32A.

On the other hand, when the predetermined time has elapsed, the HMI control unit 174 causes the navigation map displayed before the host vehicle M reaches the predetermined section to be displayed again on the screen of the first display 32A (step S108).

Next, after the HMI control unit 174 causes the navigation map to be displayed on the screen of the first display 32A again, the HMI control unit 174 determines whether the host vehicle M has approached the guidance point (for example, the branching point or the merging point) (step S110).

For example, when the host vehicle M reaches a predetermined point ahead of the guidance point as viewed from the host vehicle M, the HMI control unit 174 may determine that the host vehicle M has approached the guidance point. The predetermined point is a point for determining that the host vehicle M has approached the guidance point, and may be, for example, a point separated from the guidance point by a predetermined distance (for example, 2 km).

When the host vehicle M has not yet approached the guidance point, the HMI control unit 174 continues to cause the navigation map to be displayed on the screen of the first display 32A.

On the other hand, when the host vehicle M has approached the guidance point, the HMI control unit 174 superimposes auxiliary information on the navigation map displayed on the screen of the first display 32A (step S112).

In FIG. 5 described above, in scene S3, the host vehicle M is approaching a branching point which is one of guidance points. At the branching point, a lane LN3 branches from mainline lanes LN1 and LN2. In the present embodiment, a destination of the host vehicle M is located ahead of the branch lane LN3, and the lane LN3 is determined to be a recommended lane by the MPU 60. Therefore, the host vehicle M is guided to change lanes to the lane LN3.

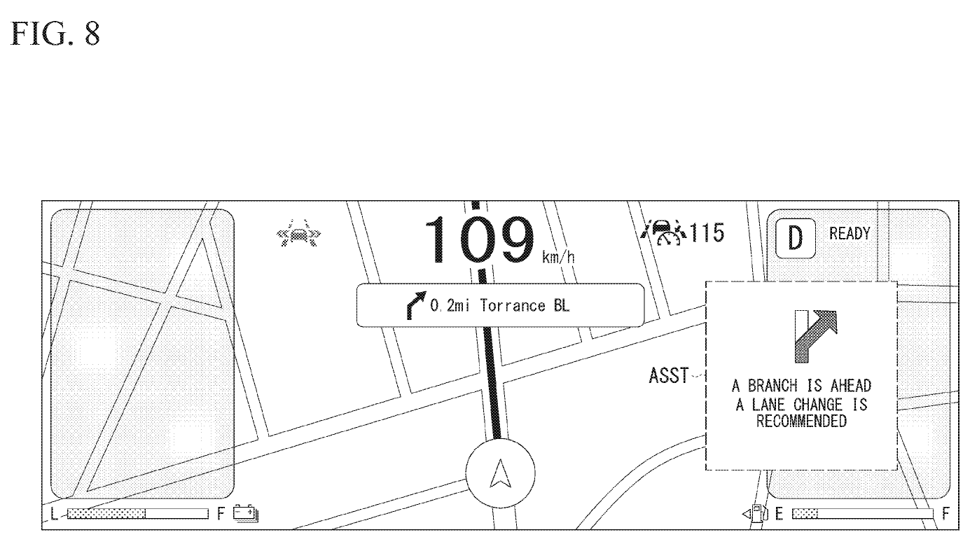

FIG. 8 is a diagram illustrating an example of a navigation map with auxiliary information. In the case of scene S3, in order to prompt the occupant to change lanes, the navigation map is displayed on the screen of the first display 32A, and further, for example, text, an icon, or an animation such as “A branch is ahead. A lane change is recommended” is displayed as the auxiliary information ASST in a superimposed manner on the navigation map.

When the HMI control unit 174 superimposes the auxiliary information on the navigation map, the HMI control unit 174 may cause sound to be output from the speaker of the HMI 30. Thus, the occupant can be notified that auxiliary information has been additionally displayed on the screen of the first display 32A.

The description returns to the flowchart. Next, the HMI control unit 174 determines whether the host vehicle M has moved to the recommended lane after superimposing the auxiliary information on the navigation map (step S114).

When the host vehicle M has not yet moved to the recommended lane, the HMI control unit 174 causes the ADAS view with auxiliary information to be displayed on the screen of the first display 32A in order to more strongly prompt the occupant to change lanes (step S116). In other words, the HMI control unit 174 causes the screen of the first display 32A to transition from the navigation map to the ADAS view.

On the other hand, when the host vehicle M has already moved to the recommended lane, the HMI control unit 174 continues to cause the navigation map to be displayed on the screen of the first display 32A (step S118).

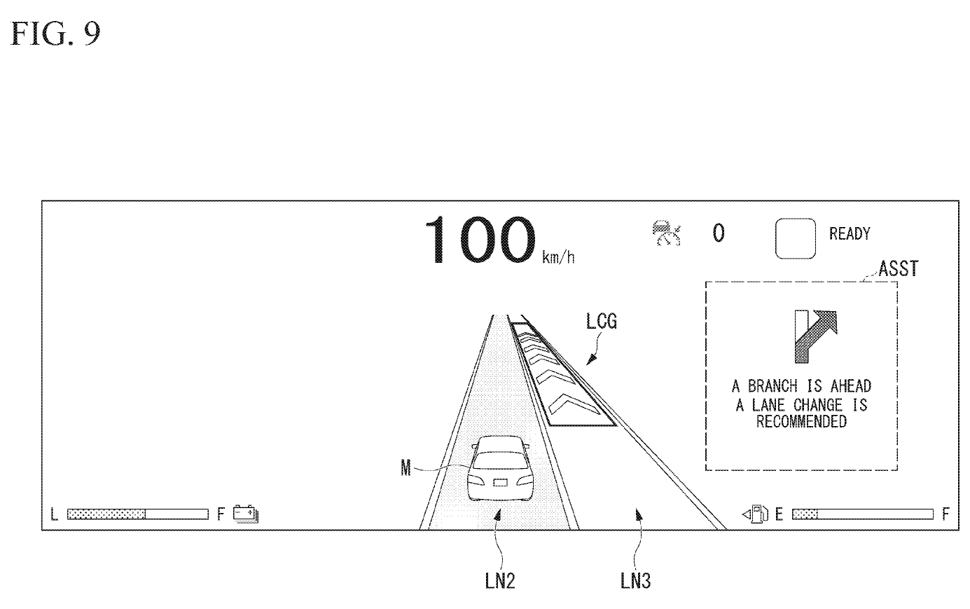

FIG. 9 is a diagram illustrating another example of the ADAS view with auxiliary information. For example, in scene S3, the host vehicle M is traveling in the lane LN2 and has not yet moved to the lane LN3 determined to be the recommended lane. In such a case, the ADAS view with auxiliary information is displayed on the screen of the first display 32A.

The ADAS view includes the lane LN2 in which the host vehicle M is traveling, the lane LN3 adjacent to the lane LN2, the host vehicle M, the lane change guide LCG, and the like, and further, text, an icon, an animation, and the like are superimposed as the auxiliary information ASST.

The lane change guide LCG is displayed in a region in which the lane LN3 of the ADAS view is drawn. In this case, in addition to a plurality of arrows represented as the lane change guide LCG, a periphery of the lane LN3 determined to be the recommended lane may be highlighted using a predetermined effect (for example, a wave-like effect). With such display of the lane change guide LCG, it is possible to strongly notify the occupant that a lane change to a right adjacent lane is required.

As described above, when the HMI control unit 174 causes the ADAS view with auxiliary information to be displayed on the screen of the first display 32A, the HMI control unit 174 may cause sound to be output from the speaker of the HMI 30.

The description returns to the flowchart. Next, the HMI control unit 174 determines whether the host vehicle M has reached the guidance point and further exited the predetermined section (step S120).

When the host vehicle M has not yet reached the guidance point and has not exited the predetermined section, the HMI control unit 174 returns the processing to S114 and continues to cause the ADAS view or the navigation map to be displayed on the screen of the first display 32A during a period until the host vehicle M reaches the guidance point and exits the predetermined section.

On the other hand, when the host vehicle M has reached the guidance point and exited the predetermined section, the HMI control unit 174 causes the navigation map with auxiliary information to be displayed on the screen of the first display 32A (step S122). Thus, the processing of the present flowchart ends.

In FIG. 5 described above, in scene S4, the host vehicle M has passed a branching point, which is one of the guidance points, and has exited the predetermined section. In such a case, the navigation map with auxiliary information is displayed on the screen of the first display 32A.

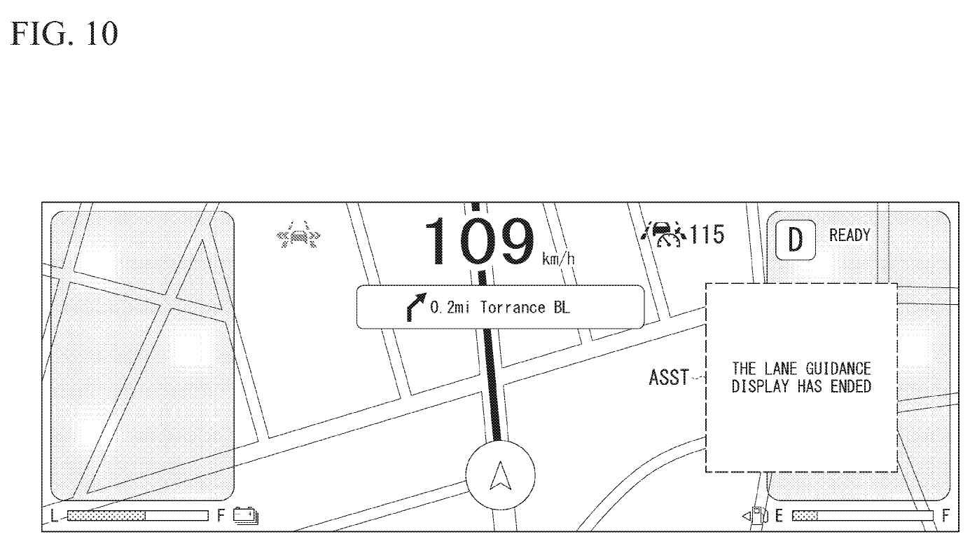

FIG. 10 is a diagram illustrating another example of the navigation map with auxiliary information. As illustrated, the current position of the host vehicle M and the route to the destination are drawn on the navigation map, and further, text such as “Lane guidance display has ended” is superimposed on the navigation map as the auxiliary information ASST in order to notify the occupant that guidance of the recommended lane has ended.

Thus, when the navigation map is selected in advance by the occupant, if the host vehicle M reaches (enters) the predetermined section, the ADAS view that has not been selected by the occupant is temporarily interrupted and displayed, or the ADAS view that has not been selected by the occupant is displayed when the host vehicle M approaches the guidance point. Thus, it is possible to also provide driving assistance information while providing navigation information desired by the occupant.

In the series of flowcharts described above, the description has been given on the premise that the occupant selects the navigation map from among a plurality of images using the command switch 34 before the host vehicle M reaches (enters) the predetermined section, but the present invention is not limited thereto.

For example, the ADAS view may be selected by the occupant before the host vehicle M reaches (enters) the predetermined section.

The auxiliary information described above is not applied to the ADAS view selected by the occupant before the host vehicle M reaches (enters) the predetermined section. This is because the auxiliary information is information for notifying the occupant, within the predetermined section, that a guidance point such as a branching point or a merging point is becoming closer or for notifying the occupant of a position of the recommended lane associated with the guidance point. Therefore, when the host vehicle M is outside the predetermined section, the auxiliary information is not added to the ADAS view.

When the ADAS view is selected in advance by the occupant, that is, when the ADAS view without auxiliary information is selected, the HMI control unit 174 switches, in each scene, an image to be displayed on the screen of the first display 32A between the ADAS view without auxiliary information and the ADAS view with auxiliary information. The ADAS view with auxiliary information is another example of the “first image,” and the ADAS view without auxiliary information is another example of the “second image.” The ADAS view without auxiliary information is an example of the “third image.”

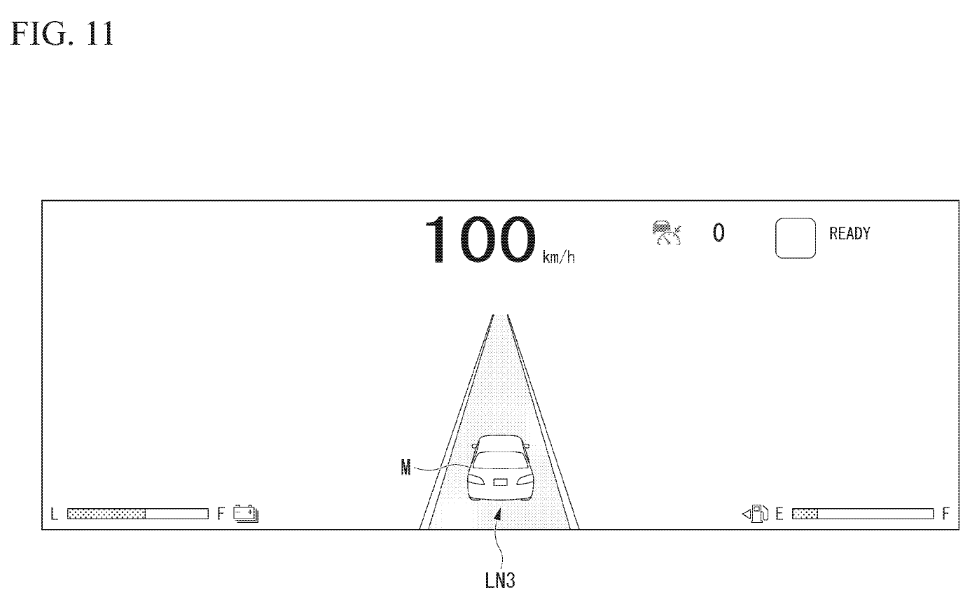

FIG. 11 is a diagram illustrating an example of the ADAS view without auxiliary information. For example, during a period until the host vehicle M reaches the predetermined section, the HMI control unit 174 may cause the ADAS view without auxiliary information as illustrated in FIG. 11 to be displayed on the screen of the first display 32A.

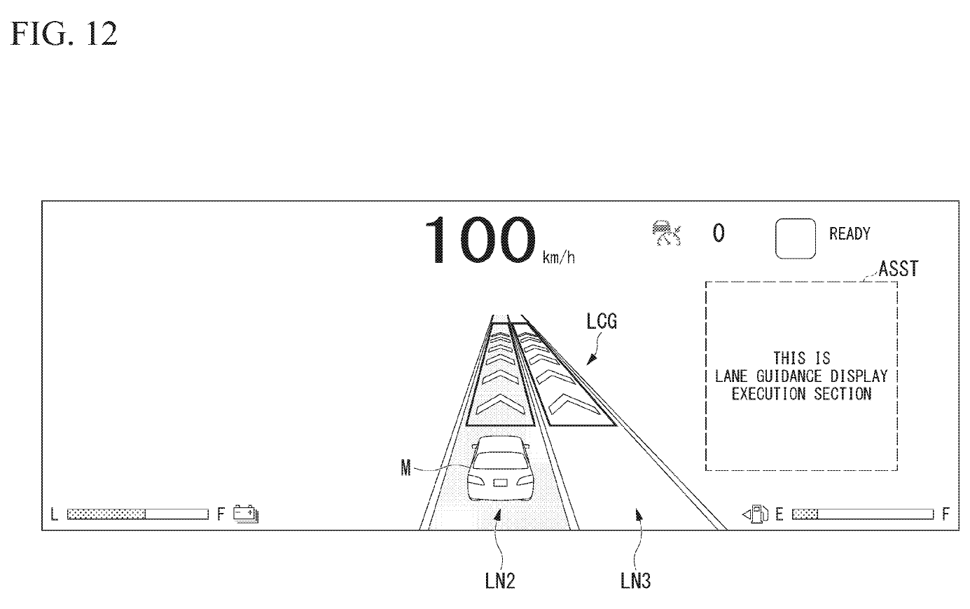

FIG. 12 is a diagram illustrating another example of the ADAS view with auxiliary information. For example, when the host vehicle M reaches the predetermined section, the HMI control unit 174 may cause, as illustrated in FIG. 12, an ADAS view in which text such as “This is a lane guidance display execution section” is superimposed as the auxiliary information ASST to be displayed on the screen of the first display 32A in order to notify the occupant that guidance of the recommended lane will start.

In other words, when the host vehicle M reaches the predetermined section, the HMI control unit 174 may cause the screen of the first display 32A to transition from the ADAS view without auxiliary information to the ADAS view with auxiliary information.

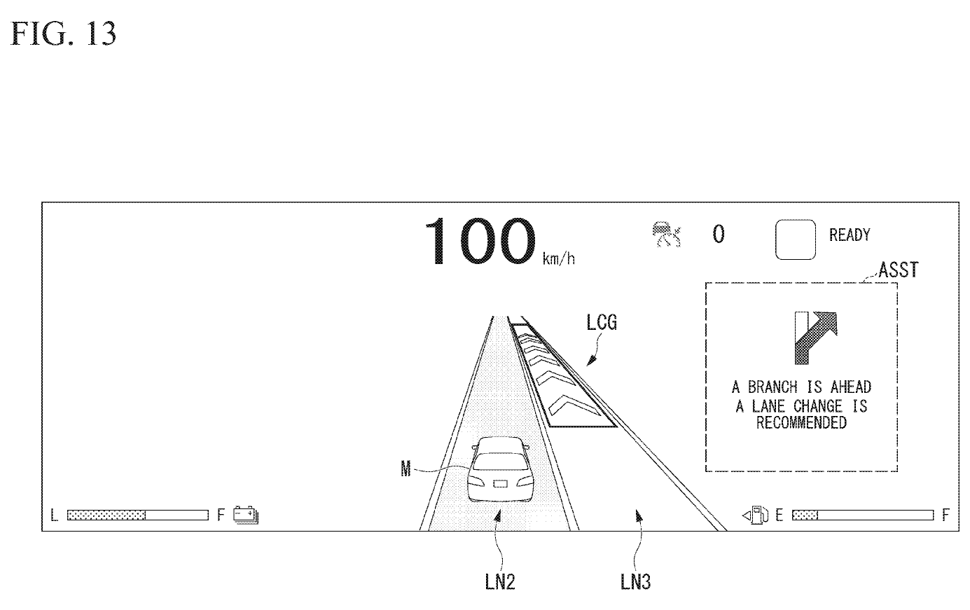

FIG. 13 is a diagram illustrating another example of the ADAS view with auxiliary information. For example, when the host vehicle M approaches the guidance point (for example, a branching point or a merging point), the HMI control unit 174 may continue to cause the ADAS view to be displayed on the screen of the first display 32A as illustrated in FIG. 13, and further change, for example, the auxiliary information ASST of the ADAS view to text, an icon, or an animation such as “A branch is ahead. A lane change is recommended.”

Furthermore, the HMI control unit 174 may display the lane change guide LCG in the region in which the lane LN3 of the ADAS view is drawn, and/or may highlight the periphery of the lane LN3 using a predetermined effect.

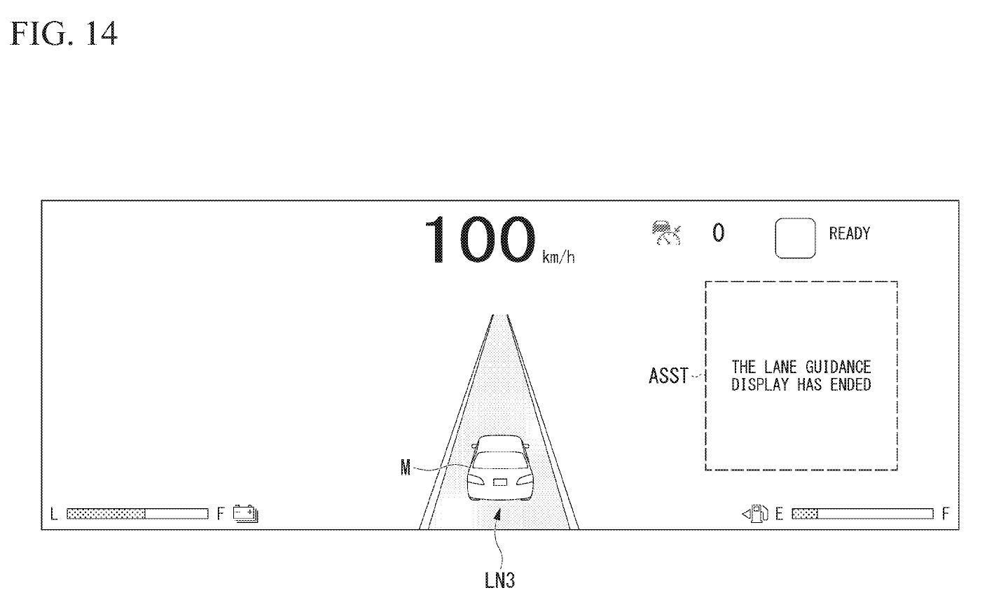

FIG. 14 is a diagram illustrating another example of the ADAS view with auxiliary information. For example, when the host vehicle M reaches the guidance point and exits the predetermined section, the HMI control unit 174 may change the auxiliary information ASST of the ADAS view to text such as “Lane guidance display has ended” in order to notify the occupant that guidance of the recommended lane has ended, as illustrated in FIG. 14.

Thus, when the ADAS view without auxiliary information is selected in advance by the occupant, if the host vehicle M reaches (enters) the predetermined section, the auxiliary information ASST is added to the ADAS view, or when the host vehicle M approaches the guidance point, the auxiliary information ASST added to the ADAS view is updated. Thus, it is possible to also provide auxiliary information while providing driving assistance information desired by the occupant.

Further, in the above-described embodiment, a case in which the ADAS view may be selected by the occupant before the host vehicle M reaches (enters) the predetermined section has been described, but the present invention is not limited thereto. For example, the occupant may select the ADAS view at any time while the host vehicle M is traveling within the predetermined section.

As described above, even when the navigation map is selected in advance, the ADAS view is temporarily interrupted and displayed instead of the navigation map during a period from when the host vehicle M reaches the predetermined section until a predetermined time has elapsed. In this case, the occupant can select the interrupted and displayed ADAS view using the command switch 34. When the interrupted and displayed ADAS view is selected, the HMI control unit 174 may continue to cause the ADAS view to be displayed until the host vehicle M exits the predetermined section.

According to the embodiment described above, when the navigation map (an example of the “second image”) is selected by the occupant before the host vehicle M reaches the predetermined section, the automated driving control device 100 causes the navigation map to be displayed on the screen of the first display 32A until the host vehicle M reaches the predetermined section, and causes an ADAS view (an example of the “first image”) to be displayed on the screen of the first display 32A for a predetermined time (for example, several seconds) when the host vehicle M reaches the predetermined section.

Furthermore, when the ADAS view is selected by the occupant before the host vehicle M reaches the predetermined section or after the host vehicle M reaches the predetermined section, the automated driving control device 100 continues to cause the ADAS view to be displayed on the screen of the first display 32A over a period during which the host vehicle M exists within the predetermined section. With such a configuration, it is possible to accurately provide information desired by the occupant, and as a result, to reduce annoyance imposed on the occupant.

### Other Embodiments

Hereinafter, other embodiments will be described. In the above-described embodiment, a case in which the navigation map or the ADAS view are displayed on the screen of the first display 32A has been described, but the present invention is not limited thereto. The navigation map or the ADAS view may be displayed on a screen of the second display 32B instead of the first display 32A, or may be displayed on another display device (for example, a head-up display).

Further, in the above-described embodiment, a case in which the navigation map or the ADAS view is selected by the occupant has been described, but the present invention is not limited thereto. For example, the occupant may select different types of navigation maps, such as the bird’s-eye view, the two-dimensional view (2D view), and the three-dimensional view (3D view).

For example, it is assumed that a three-dimensional view is selected by the occupant before the host vehicle M reaches the predetermined section. It is further assumed that, after the host vehicle M reaches the predetermined section, another image different from the three-dimensional view (for example, the bird’s-eye view, the two-dimensional view, or the ADAS view) is not selected by the occupant.

In such a case, the HMI control unit 174 switches, in each scene, the image to be displayed on the screen of the first display 32A between a three-dimensional view without auxiliary information and a three-dimensional view with auxiliary information. The three-dimensional view with auxiliary information is another example of the “first image,” and the three-dimensional view without auxiliary information is another example of the “second image.” The three-dimensional view without auxiliary information is another example of the “third image.”

As described above, when the three-dimensional view without auxiliary information is selected in advance by the occupant, if the host vehicle M reaches (enters) the predetermined section, the auxiliary information ASST is added to the three-dimensional view or when the host vehicle M approaches the guidance point, the auxiliary information ASST added to the three-dimensional view is updated. Thus, it is possible to provide the auxiliary information while providing the three-dimensional view desired by the occupant.

Although embodiments for carrying out the present invention have been described above using the embodiments, the present invention is not limited to such embodiments in any way, and various modifications and substitutions may be made without departing from the gist of the present invention.

What is claimed is:

1. A display device comprising:
an output interface including at least a display;
an input interface operated by an occupant of a vehicle; and
a display control unit configured to, when the occupant selects any one of a plurality of images that are candidates to be displayed on the display using the input interface, cause the image selected by the occupant to be displayed on the display,
wherein the display control unit is configured to
cause a first image included in the plurality of images to be displayed on the display when the vehicle exists within a predetermined section;
continue to cause the first image to be displayed on the display over a period during which the vehicle exists within the predetermined section, when the first image is selected by the occupant and the vehicle exists within the predetermined section;
cause the first image to be displayed on the display when the vehicle enters the predetermined section; and
cause the first image to be displayed on the display during a period from when the vehicle enters the predetermined section until a predetermined time has elapsed, when a second image included in the plurality of images and different from the first image is selected by the occupant before the vehicle enters the predetermined section, and cause the second image to be displayed on the display after the predetermined time has elapsed.

2. The display device according to claim 1, wherein the display control unit
guides a route to a destination using the output interface; and
causes the first image to be displayed on the display again when the vehicle has reached a predetermined point ahead of a guidance point present on the route, the guidance point being a point at which a traveling direction of the vehicle is to be changed after causing the second image to be displayed on the display.

3. The display device according to claim 2, wherein the display control unit continues to cause the first image to be displayed on the display even after the vehicle enters the predetermined section when the first image is selected by the occupant before the vehicle enters the predetermined section.

4. The display device according to claim 2, wherein the display control unit
outputs, using the output interface, guidance information indicating that the guidance point is becoming closer before the vehicle reaches the guidance point,
causes the first image to be displayed on the display when the vehicle does not move in accordance with the guided route after the guidance information is output, and
does not cause the first image to be displayed on the display when the vehicle has moved in accordance with the guided route after the guidance information is output.

5. The display device according to claim 2, wherein the display control unit causes the second image to be displayed on the display when the vehicle has passed through the predetermined point.

6. The display device according to claim 1,
wherein the display control unit causes the first image to be displayed on the display during a period from when the vehicle enters the predetermined section until a predetermined time has elapsed, when a third image included in the plurality of images and different from the first image and the second image is selected by the occupant before the vehicle enters the predetermined section, and cause the first image to continue to be displayed on the display after the predetermined time has elapsed.

7. The display device according to claim 1, wherein the predetermined section is a section in which an expressway or an automobile-only road exists.

8. The display device according to claim 1, wherein the first image includes guidance information for guiding the occupant to positions of a host lane that is a lane in which the vehicle exists, an adjacent lane that is another lane adjacent to the host lane, an object present around the vehicle, and a recommended lane that is a lane recommended to be traveled by the vehicle.

9. A display method using a computer mounted on a vehicle including an output interface including at least a display, and an input interface, the display method comprising:
causing an image selected by an occupant of the vehicle to be displayed on the display when the occupant selects any one of a plurality of images that are candidates to be displayed on the display using the input interface;
causing a first image included in the plurality of images to be displayed on the display when the vehicle exists within a predetermined section;
continuing to cause the first image to be displayed on the display over a period during which the vehicle exists within the predetermined section, when the first image is selected by the occupant and the vehicle exists within the predetermined section;
causing the first image to be displayed on the display when the vehicle enters the predetermined section;
causing the first image to be displayed on the display during a period from when the vehicle enters the predetermined section until a predetermined time has elapsed, when a second image included in the plurality of images and different from the first image is selected by the occupant before the vehicle enters the predetermined section; and
causing the second image to be displayed on the display after the predetermined time has elapsed.

10. A non-transitory storage medium storing a program caused to be executed by a computer mounted on a vehicle including an output interface including at least a display, and an input interface, the program comprising:
causing an image selected by an occupant of the vehicle to be displayed on the display when the occupant selects any one of a plurality of images that are candidates to be displayed on the display using the input interface;
causing a first image included in the plurality of images to be displayed on the display when the vehicle exists within a predetermined section;
continuing to cause the first image to be displayed on the display over a period during which the vehicle exists within the predetermined section, when the first image is selected by the occupant and the vehicle exists within the predetermined section;
causing the first image to be displayed on the display when the vehicle enters the predetermined section;
causing the first image to be displayed on the display during a period from when the vehicle enters the predetermined section until a predetermined time has elapsed, when a second image included in the plurality of images and different from the first image is selected by the occupant before the vehicle enters the predetermined section; and
causing the second image to be displayed on the display after the predetermined time has elapsed.
